(19) United States
(12) Patent Application Publication
(10) Pub. No.: US 2026/0030853 A1
(43) Pub. Date: Jan. 29, 2026

(54) INFORMATION PROCESSING APPARATUS CAPABLE OF REDUCING DIFFERENCE BETWEEN USER'S VISION AND BODILY SENSATION EVEN DURING RIDING ON VEHICLE AND CAPABLE OF PREVENTING DECREASE IN IMMERSION SENSE IN DISPLAY USING XR TECHNOLOGY, CONTROL METHOD FOR INFORMATION PROCESSING APPARATUS, AND STORAGE MEDIUM

(71) Applicant: CANON KABUSHIKI KAISHA, Tokyo (JP)

(72) Inventor: TETSUHIKO YAO, Tokyo (JP)

(21) Appl. No.: 19/238,972

(22) Filed: Jun. 16, 2025

(30) Foreign Application Priority Data
Jul. 24, 2024 (JP) 2024-118625

(51) Int. Cl. G06T 19/20; G06F 3/01; G06T 5/50; G06T 19/00

(52) U.S. Cl. CPC G06T 19/20; G06F 3/012; G06T 5/50; G06T 19/006; G06T 2207/20221; G06T 2219/2004

(57) ABSTRACT

An information processing apparatus that is capable of reducing a difference between a user's vision and bodily sensation even during riding on a vehicle and is capable of preventing a decrease in an immersion sense in a display using XR technology, is provided. The information processing apparatus includes one or more processors and/or circuitry configured to execute a position obtainment processing that obtains a position and an attitude of a user of a head mounted display, execute a movement information obtainment processing that obtains movement information of a moving body on which the user is riding, execute a rendering processing that renders a first CG object based on the position and the attitude of the user and renders a second CG object based on the movement information of the moving body, and execute a display processing that displays an image including the first CG object and the second CG object.

### BACKGROUND

### Field of the Technology

The present disclosure relates to an information processing apparatus, a control method for the information processing apparatus, and a storage medium, and in particular to an information processing apparatus that performs image rendering based on a plurality of pieces of position information, a control method for the information processing apparatus, and a storage medium.

### Description of the Related Art

In recent years, virtual reality (VR) technology, which uses an information processing apparatus such as a head mounted display (an HMD) to allow a user to visually sense himself/herself as being in a virtual space, and augmented reality (AR) and mixed reality (MR) technologies, which superimpose virtual object(s) on object(s) in the real world, are beginning to be put into practical use. These technologies are collectively referred to as extended reality/cross reality (XR) technology.

When trying to use the XR technology in situations such as when riding on a vehicle such as a car or an airplane, there is a problem in that the accuracies of estimating a self-position and an attitude decrease. In order to solve this problem, in a technique disclosed in Japanese Patent No. 7147775, which information of image information obtained from an image pickup apparatus and inertial information obtained from an inertial sensor to be used more reliably is changed depending on the situation.

However, with the technique disclosed in Japanese Patent No. 7147775, even when a user is riding on a vehicle, the user's movement status, which includes the movement of the vehicle itself, is not reflected on a display of an information processing apparatus, and there is a case where the display appears as if no movement has occurred. In this case, the user experiences an acceleration (G) caused by the movement of the vehicle, but since the movement of the vehicle is not capable of being confirmed visually, this will cause nausea and led to a decrease in an immersion sense in a display using the XR technology.

### SUMMARY

The present disclosure provides an information processing apparatus that is capable of reducing a difference between a user's vision and bodily sensation even during riding on a vehicle and is capable of preventing a decrease in an immersion sense in a display using the XR technology, a control method for the information processing apparatus, and a storage medium.

Accordingly, an aspect of the present disclosure provides an information processing apparatus comprising one or more processors and/or circuitry configured to execute a position obtainment processing that obtains a position and an attitude of a user of a head mounted display, execute a movement information obtainment processing that obtains movement information of a moving body on which the user is riding, execute a rendering processing that renders a first CG object based on the position and the attitude of the user and renders a second CG object based on the movement information of the moving body, and execute a display processing that displays an image including the first CG object and the second CG object.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a hardware configuration of an XR system as an information processing apparatus according to the present disclosure.

FIG. 2 is a diagram that illustrates a position of a user who uses the XR system while riding on a Shinkansen train.

FIG. 3 is a diagram for explaining two coordinate systems used by the XR system.

FIG. 4 is a diagram that illustrates an example of a field of vision when the user is using the XR system in an augmented reality mode on the Shinkansen train.

FIG. 5 is a diagram that illustrates an example of a field of vision when the user is using the XR system in a virtual reality mode on the Shinkansen train.

FIG. 6 is a block diagram that illustrates a software configuration of the XR system in a first embodiment.

FIG. 7 is a diagram that illustrates an example in the first embodiment of data retained by CG object data illustrated in FIG. 6.

FIG. 8 is a diagram that illustrates an example in the first embodiment of data retained by CG instance data illustrated in FIG. 6.

FIG. 9 is a diagram that illustrates examples in the first embodiment of a first rendering result, a second rendering result, and a composited rendering result that are illustrated in FIG. 6.

FIG. 10 is a flowchart of a composited rendering result generation processing executed by a composite processing section illustrated in FIG. 6.

FIG. 11 is a diagram for explaining a time-series change in the composited rendering result in the first embodiment.

FIG. 12 is a diagram that illustrates an example in a second embodiment of data retained by CG instance data.

FIG. 13 is a diagram for explaining time-series changes in a first rendering result, a second rendering result, and a composited rendering result in the second embodiment.

FIG. 14 is a block diagram that illustrates a software configuration of the XR system in a third embodiment.

### DESCRIPTION OF THE EMBODIMENTS

The present disclosure will now be described in detail below with reference to the accompanying drawings showing embodiments thereof.

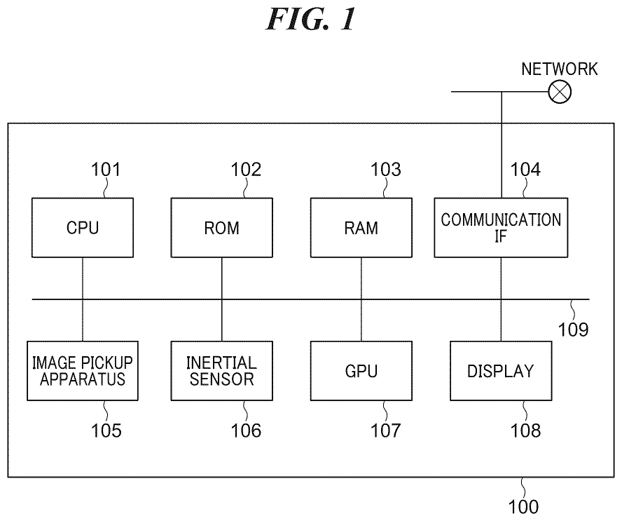

A basic configuration of an information processing apparatus according to the present disclosure will be described with reference to FIG. 1. FIG. 1 is a block diagram that illustrates a hardware configuration of an XR system 100 as the information processing apparatus according to the present disclosure.

As shown in FIG. 1, the XR system 100 includes a central processing unit (a CPU) 101, a read only memory (a ROM) 102, a random access memory (a RAM) 103, a communication IF (an interface unit) 104, an image pickup apparatus 105, an inertial sensor 106, a graphic processing unit (a GPU) 107, and a display 108, and each of the components is connected by a bus 109.

The CPU 101 executes programs that have been stored in the ROM 102 and programs that have been loaded into the RAM 103, and performs the operation control of the XR system 100. The ROM 102 is a read only memory, and stores a boot program, firmware, various kinds of processing programs for implementing processes described below, and various kinds of data. The RAM 103 is a working memory that temporarily stores programs and data for processing performed by the CPU 101, and various kinds of processing programs and data are loaded into the RAM 103 by the CPU 101.

The communication IF 104 is an interface for communicating with external device(s) via a network (see FIG. 1), and transmits and receives various kinds of data via the network.

The image pickup apparatus 105 is, for example, a camera, and obtains (captures) a real video image of the surroundings of the XR system 100.

The inertial sensor 106 includes a three-axis acceleration sensor that detects accelerations in three axial directions, and an angular velocity sensor that detects angular velocities around three axes. The inertial sensor 106 obtains the accelerations in the three axial directions and the angular velocities around the three axes, which have been obtained, as inertial information.

The GPU 107 performs image processing according to programs that have been stored in the ROM 102 and programs that have been loaded into the RAM 103. The GPU 107 cooperates with the CPU 101 to realize the software functions of the XR system 100, and generates images such as a first rendering result 608, a second rendering result 610, and a composited rendering result 612, which will be described below.

The display 108 displays an image that has been generated by the CPU 101 or the GPU 107 and presents the image to a user. The display 108 is a head mounted display, and may be a retinal projection type head display that projects the display of a display panel, or a retinal scanning type head mounted display that directly renders an image on the retina.

The bus 109 connects various kinds of devices.

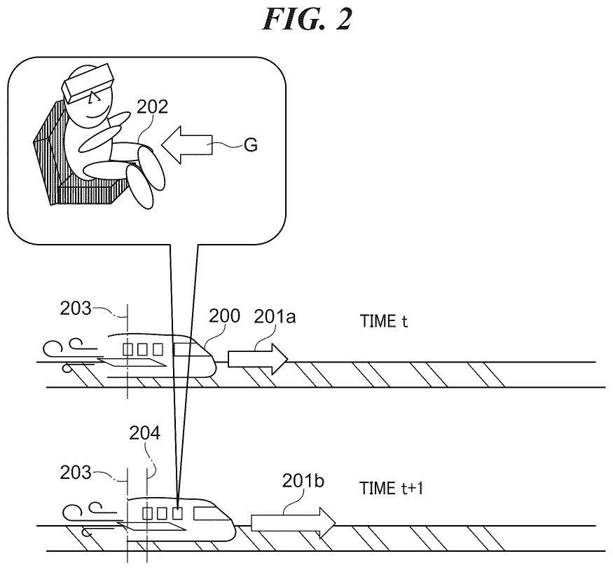

FIG. 2 is a diagram that illustrates a position of a user 202 who uses the XR system 100 while riding on a Shinkansen train 200 (a moving body), which is an example of a vehicle.

As shown in FIG. 2, a velocity vector 201a indicates a velocity of the Shinkansen train 200 at a time t.

A time t position 203 is a position of the user 202 at the time t.

A velocity vector 201b indicates a velocity of the Shinkansen train 200 at a time t+1.

A time t+1 position 204 is a position of the user 202 at the time t+1.

In this way, between the time t and the time t+1, the velocity of the Shinkansen train 200 changes from the velocity vector 201a to the velocity vector 201b. The user 202 who is riding on the Shinkansen train 200 experiences the movement of the Shinkansen train 200 due to this change (an acceleration (G)).

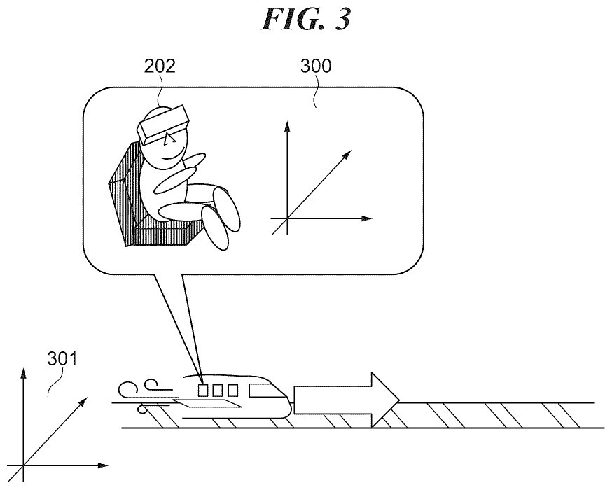

FIG. 3 is a diagram for explaining two coordinate systems used by the XR system 100.

As shown in FIG. 3, a moving body coordinate system 300 is a coordinate system based on the Shinkansen train 200 (the moving body) that is moving while carrying the user 202, and coordinates of the user 202 based on the moving body coordinate system 300 are affected by the movement of the user 202.

A world coordinate system 301 is a coordinate system based on the Earth, and coordinates of the user 202 based on the world coordinate system 301 are affected by the movement of the Shinkansen train 200 and the movement of the user 202.

It should be noted that in the present disclosure, the XR system 100 uses the two coordinate systems, that is, the moving body coordinate system 300 and the world coordinate system 301, but it is sufficient that the number of coordinate systems used by the XR system 100 is two or more.

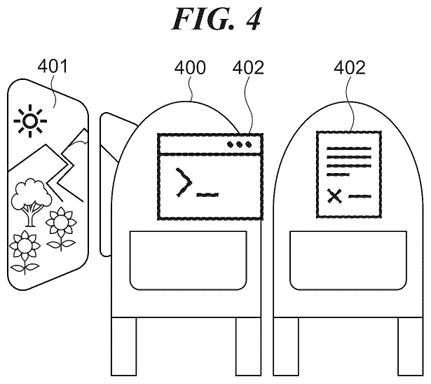

FIG. 4 is a diagram that illustrates an example of a field of vision when the user 202 is using the XR system 100 in an augmented reality mode (an AR mode) on the Shinkansen train 200.

As shown in FIG. 4, an inside the Shinkansen train 400 and a scenery from the train window 401 are real video images.

A virtual window 402 is a virtual object that is rendered as computer graphics (CG) on the display 108 of the XR system 100 used by the user 202, and follows the moving body coordinate system 300.

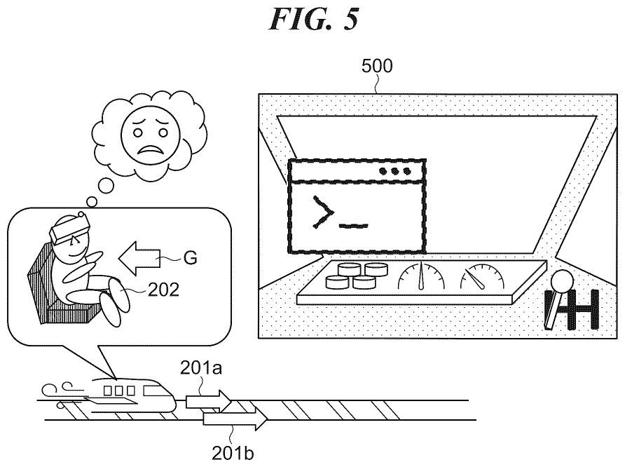

FIG. 5 is a diagram that illustrates an example of a field of vision when the user 202 is using the XR system 100 in a virtual reality mode (a VR mode) on the Shinkansen train 200.

As shown in FIG. 5, an inside the train that is a virtual space (hereinafter, referred to as “an inside train of a virtual space”) 500 is a video image that is rendered as CG on the display 108 of the XR system 100 used by the user 202, and follows the moving body coordinate system 300.

In this way, in the case where only the inside train of the virtual space 500 is displayed on the display 108, even when the user 202 is experiencing the acceleration (G) as shown in FIG. 2, the video image of the inside train of the virtual space 500 is still. As a result, the user 202 feels a discrepancy (difference) between his/her vision and bodily sensation, and his/her immersion sense in the inside train of the virtual space 500 decreases.

In the following embodiments, a main configuration and processing procedure for preventing a decrease in the immersion sense in the XR system 100 will be described.

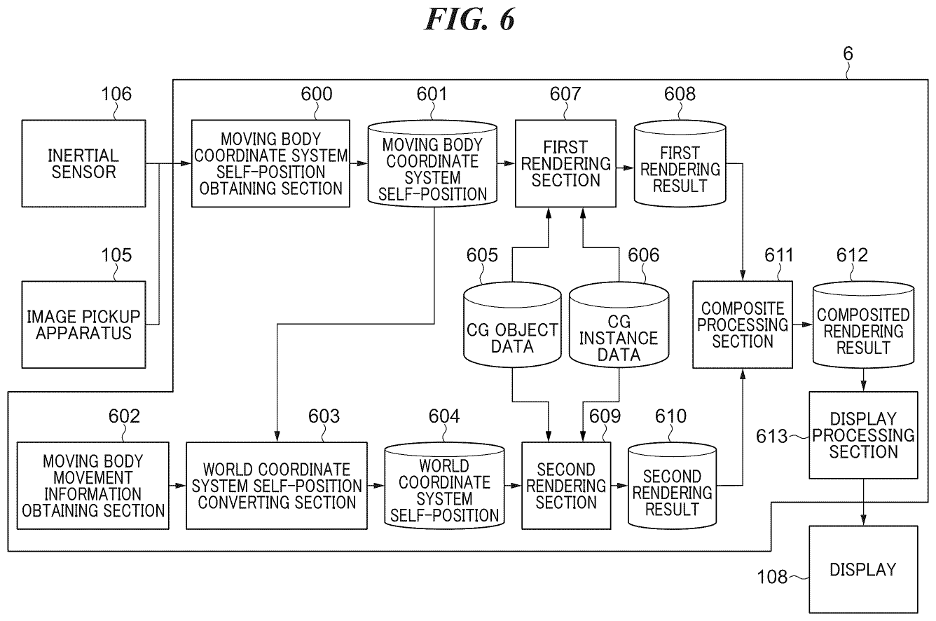

First, a first embodiment will be described. FIG. 6 is a block diagram that illustrates a software configuration 6 of the XR system 100 in the first embodiment. The functions of the software configuration 6 are realized by the CPU 101 and the GPU 107 cooperating with each other.

As shown in FIG. 6, the software configuration 6 includes a moving body coordinate system self-position obtaining section 600, a moving body movement information obtaining section 602, a world coordinate system self-position converting section 603, a first rendering section 607, a second rendering section 609, a composite processing section 611, and a display processing section 613.

The moving body coordinate system self-position obtaining section 600 (a position obtaining unit) obtains a moving body coordinate system self-position 601 which is a self-position and an attitude of the XR system 100 in the moving body coordinate system 300. As disclosed in Japanese Patent No. 7147775, the self-position may be obtained by changing a ratio of image information obtained from the image pickup apparatus 105 and the inertial information obtained from the inertial sensor 106, which information of the image information and the inertial information is to be used more reliably, depending on the situation of the user 202.

The moving body movement information obtaining section 602 obtains movement information of the moving body (here, the Shinkansen train 200). The movement information to be obtained may be a position of the moving body in the world coordinate system 301, or may be a velocity vector or an acceleration vector of the moving body in the world coordinate system 301. The moving body movement information obtaining section 602 obtains the movement information of the moving body by inquiring of the moving body. In the case where information on the velocity vector or the acceleration vector of the moving body is obtained as the movement information of the moving body, the moving body movement information obtaining section 602 calculates the position of the moving body in the world coordinate system 301 by performing an integration process with respect to the obtained information.

The world coordinate system self-position converting section 603 (the position obtaining unit) obtains a world coordinate system self-position 604, which is a self-position and an attitude of the XR system 100 in the world coordinate system 301, based on the moving body coordinate system self-position 601, and the movement information of the moving body that has been obtained from the moving body movement information obtaining section 602. Specifically, first, translation information (Tx, Ty, Tz), i.e., parallel movement information (Tx, Ty, Tz) of the moving body is obtained from the moving body movement information obtaining section 602, and based on the parallel movement information (Tx, Ty, Tz), a transformation matrix (MovToWldMat) expressed by the following Expression 1 is generated. Next, coordinates (Mx, My, Mz) of the moving body coordinate system self-position 601 are transformed into coordinates (Wx, Wy, Wz) of the world coordinate system self-position 604 by using the transformation matrix (MovToWldMat).

$$MovToWldMat = ( \begin{matrix}1 & 0 & 0 & Tx \\ 0 & 1 & 0 & Ty \\ 0 & 0 & 1 & Tz \\ 0 & 0 & 0 & 1\end{matrix} ) \qquad [ Expression 1 ]$$

CG object data 605 stores information about CG objects to be rendered by the first rendering section 607 and the second rendering section 609.

CG instance data 606 stores CG instances including position and coordinate system information of the CG objects to be rendered by the first rendering section 607 and the second rendering section 609 for each application selectable in the virtual reality mode.

The first rendering section 607 (a rendering unit) generates an image that is the first rendering result 608 obtained by rendering, at the moving body coordinate system self-position 601, the CG object data 605 to be a target. Here, the inside train of the virtual space 500 (see FIG. 5) is displayed as the first rendering result 608.

The second rendering section 609 (the rendering unit) generates an image that is the second rendering result 610 obtained by rendering, at the world coordinate system self-position 604, the CG object data 605 to be a target.

The composite processing section 611 generates an image as the composited rendering result 612 by compositing the image that is the first rendering result 608 with the image that is the second rendering result 610.

The display processing section 613 displays the image, which is the composited rendering result 612, on the display 108.

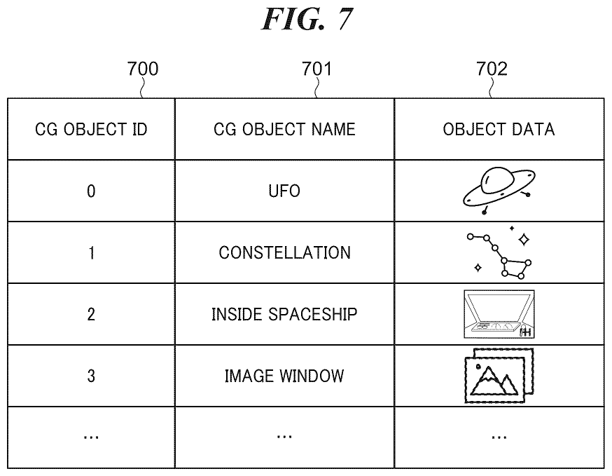

FIG. 7 is a diagram that illustrates an example in the first embodiment of data retained by the CG object data 605.

As shown in FIG. 7, a CG object ID 700 retains information that uniquely identifies a CG object.

A CG object name 701 retains a name of the CG object.

Object data 702 retains CG object information to be a rendering target.

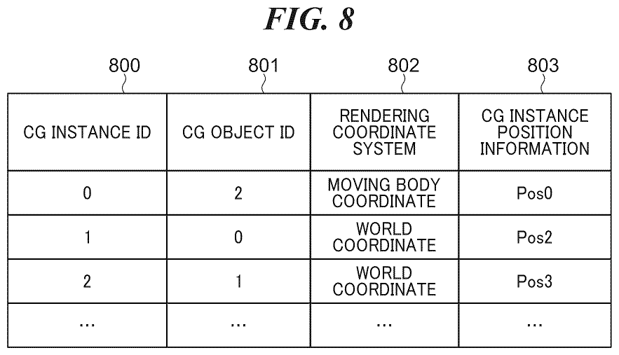

FIG. 8 is a diagram that illustrates an example in the first embodiment of data retained by the CG instance data 606.

As shown in FIG. 8, a CG instance ID 800 retains information that uniquely identifies a CG instance.

A CG object ID 801 retains an ID of a CG object to be rendered by a target CG instance among CG objects shown in FIG. 7.

A rendering coordinate system 802 retains information on whether the target CG instance is rendered by using a position calculated in the world coordinate system 301 or in the moving body coordinate system 300. In other words, each of the CG objects shown in FIG. 7 is linked to either the world coordinate system 301 or the moving body coordinate system 300.

CG instance position information 803 retains position information at which the target CG instance is placed in the rendering coordinate system 802. It should be noted that although not shown in FIG. 8, the CG instance position information 803 may also retain attitude information indicating an attitude in which the target CG instance is placed.

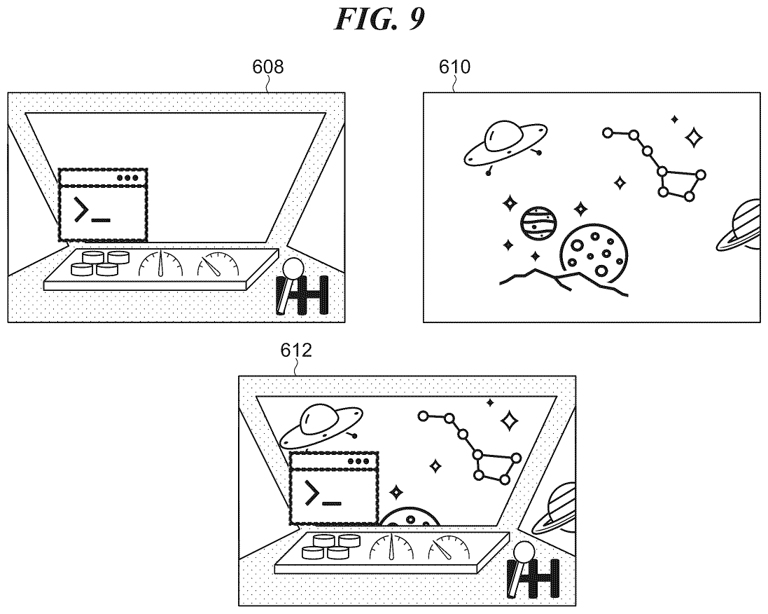

FIG. 9 is a diagram that illustrates examples in the first embodiment of the first rendering result 608, the second rendering result 610, and the composited rendering result 612.

As shown in FIG. 9, the first rendering result 608 and the second rendering result 610 each retain color information and depth information for each pixel. The composited rendering result 612 is a result of compositing the first rendering result 608 with the second rendering result 610.

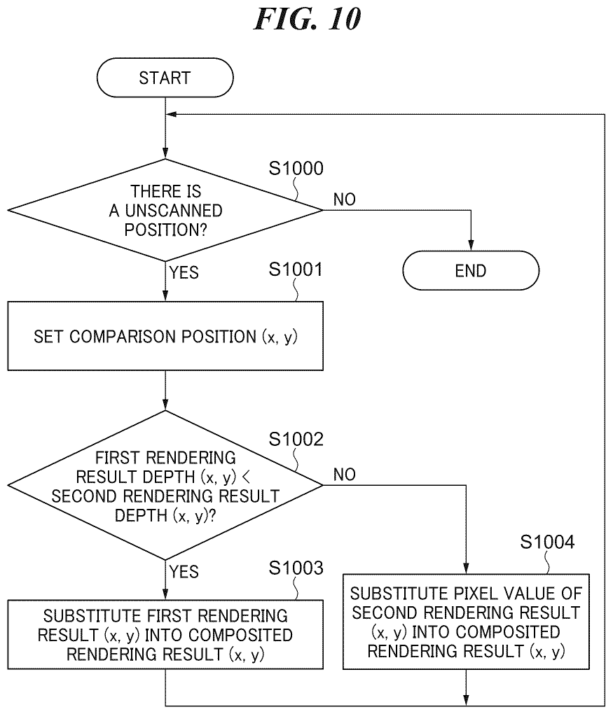

FIG. 10 is a flowchart of a composited rendering result generation processing executed by the composite processing section 611.

As shown in FIG. 10, first, in a step S1000, the composite processing section 611 determines whether or not scanning of all pixels of the rendering result has been completed. In the case of being determined that there is an unscanned position (an unscanned pixel) (YES in the step S1000), the composited rendering result generation processing proceeds to a step S1001. On the other hand, in the case of being determined that there is no unscanned position (unscanned pixel) (NO in the step S1000), the composite processing section 611 ends the composited rendering result generation processing.

In the step S1001, the composite processing section 611 sets one position extracted from a group of unscanned positions (an unscanned position group) as a comparison position (x, y).

Next, in a step S1002, the composite processing section 611 determines whether or not a depth of the first rendering result at the comparison position (x, y) is smaller than a depth of the second rendering result at the comparison position (x, y). In the case of being determined that the depth of the first rendering result at the comparison position (x, y) is smaller than the depth of the second rendering result at the comparison position (x, y) (YES in the step S1002), the composited rendering result generation processing proceeds to a step S1003. On the other hand, in the case of being determined that the depth of the first rendering result at the comparison position (x, y) is equal to or larger than the depth of the second rendering result at the comparison position (x, y) (NO in the step S1002), the composited rendering result generation processing proceeds to a step S1004.

In the step S1003, the composite processing section 611 substitutes the first rendering result at the comparison position (x, y) into the composited rendering result at the comparison position (x, y), and the composited rendering result generation processing returns to the step S1000.

In the step S1004, the composite processing section 611 substitutes the second rendering result at the comparison position (x, y) into the composited rendering result at the comparison position (x, y), and the composited rendering result generation processing returns to the step S1000.

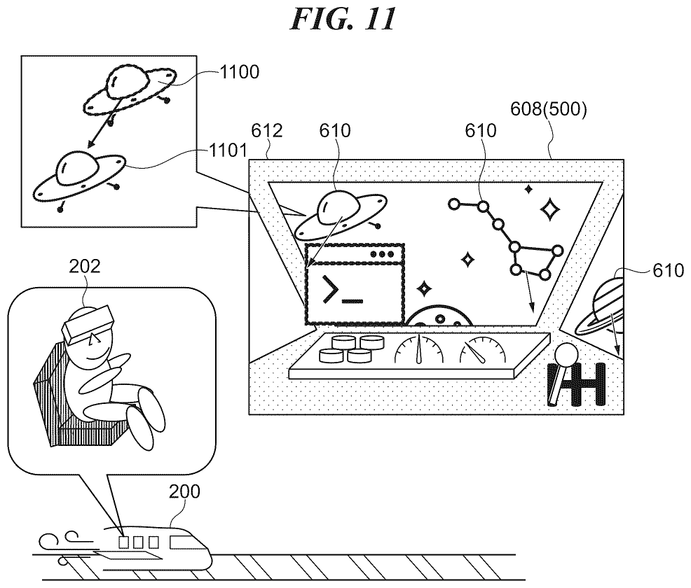

FIG. 11 is a diagram for explaining a time-series change in the composited rendering result 612 in the first embodiment.

As shown in FIG. 11, the composited rendering result 612 is rendered on the display 108 when the user 202 who is riding on the Shinkansen train 200 is using the XR system 100 in the virtual reality mode. The second rendering result 610 included in the composited rendering result 612 changes in accordance with the world coordinate system self-position 604. In addition, the first rendering result 608 included in the composited rendering result 612 is the same as the inside train of the virtual space 500 that has been shown in FIG. 5, and changes in accordance with the moving body coordinate system self-position 601. For example, between the time t and the time t+1 that have been shown in FIG. 2, the CG instance of the second rendering result 610 moves from a time t rendering position 1100 to a time t+1 rendering position 1101, but the CG instance of the first rendering result 608 does not move because it is displayed in the moving body coordinate system 300.

As described above, according to the first embodiment, by changing the second rendering result 610 rendered on the display 108 in accordance with the world coordinate system self-position 604, it is possible to visually convey to the user 202 the movement information of the Shinkansen train 200, which is the moving body. As a result, it is possible to reduce the difference between the vision and the bodily sensation of the user 202, and a decrease in the immersion sense of the user 202 in the inside train of the virtual space 500 is prevented.

Next, a second embodiment will be described. In the first embodiment, a method for realizing the functions of the software configuration 6, in which the CG instance data 606 retains the rendering coordinate system 802 that indicates whether each of the CG instance data 606 is rendered in the world coordinate system or in the moving body coordinate system, has been described. On the other hand, in the second embodiment, a method for realizing the functions of the software configuration 6 in the case where CG objects to be rendered in the world coordinate system are not registered in any of the applications selectable in the virtual reality mode will be described.

Hereinafter, in the second embodiment, the same components as those in the first embodiment will be described by using the same reference numerals.

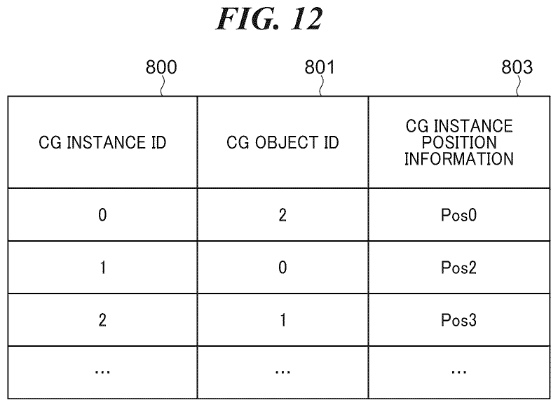

FIG. 12 is a diagram that illustrates an example in the second embodiment of data retained by CG instance data 606.

As shown in FIG. 12, a CG instance ID 800 retains information that uniquely identifies a CG instance.

A rendering CG object ID 801 retains an ID of a CG object to be rendered by a target CG instance.

CG instance position information 803 retains position information at which the target CG instance is placed in the moving body coordinate system. It should be noted that the CG instance position information 803 may also retain attitude information of the target CG instance.

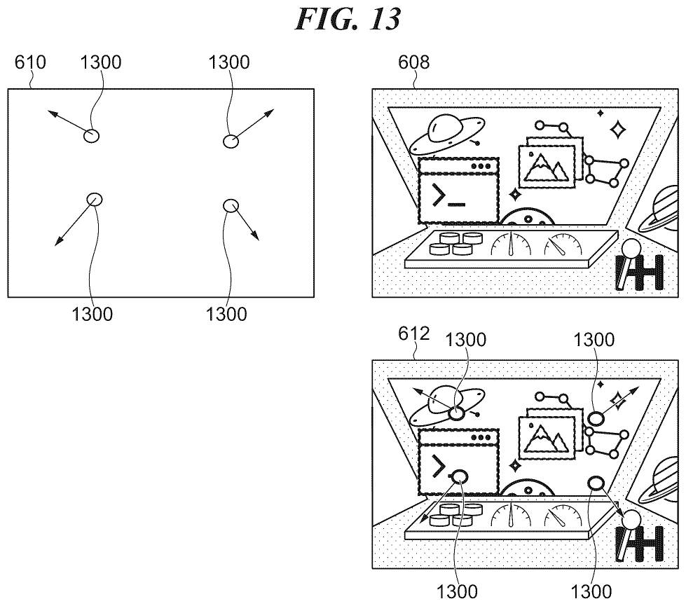

In the second embodiment, the first rendering section 607 handles all of the CG instance data 606 (first CG objects) stored for each application selectable in the virtual reality mode as rendering targets. On the other hand, the second rendering section 609 handles, as a rendering target, an application-independent CG object (a second CG object) that has been registered in CG object data 605 as an initial setting, here, a sphere object 1300 shown in FIG. 13.

FIG. 13 is a diagram for explaining time-series changes in a first rendering result 608, a second rendering result 610, and a composited rendering result 612 in the second embodiment.

The sphere object 1300 is rendered in the second rendering result 610. The sphere object 1300 is the application-independent CG object that has been registered in the CG object data 605 as the initial setting.

The first rendering result 608 is a result of rendering the CG instance data 606 that is the above rendering targets.

The composited rendering result 612 is a result of compositing the first rendering result 608 with the second rendering result 610, and the sphere object 1300, which is the second rendering result 610, changes in accordance with the world coordinate system self-position 604.

As described above, according to the second embodiment, although no CG object for the world coordinate system self-position 604 is registered in any of the applications, the sphere object 1300, which is the CG data in the initial setting, is changed in accordance with the world coordinate system self-position 604. As a result, by visually conveying to the user 202 the movement information of the Shinkansen train 200, which is the moving body, a difference between the vision and the bodily sensation of the user is reduced, and a decrease in the immersion sense in the system is prevented.

Next, a third embodiment will be described. In the first embodiment and the second embodiment, the case has been described where the moving body movement information obtaining section 602 is capable of obtaining the movement information of the moving body from the Shinkansen train 200 itself, which is the moving body. In the third embodiment, a method for obtaining the movement information of the moving body in the case where the moving body movement information obtaining section 602 does not exist will be described.

Hereinafter, in the third embodiment, the same components as those in the first embodiment will be described by using the same reference numerals.

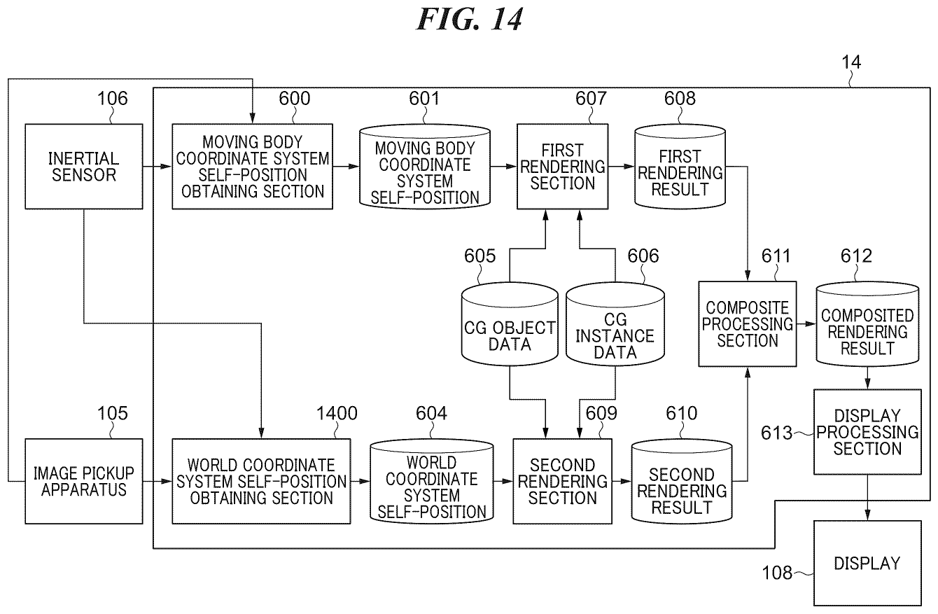

FIG. 14 is a block diagram that illustrates a software configuration 14 of the XR system 100 in the third embodiment. Only the differences from FIG. 6 will be described below. Similar to the software configuration 6 (see FIG. 6), the functions of the software configuration 14 are realized by the CPU 101 and the GPU 107 cooperating with each other.

A world coordinate system self-position obtaining section 1400 calculates a world coordinate system self-position 604, which is a self-position and an attitude of the XR system 100 in the world coordinate system 301. For example, by using the image information obtained from the image pickup apparatus 105 and the inertial information obtained from the inertial sensor 106, a range that matches a moving velocity obtained from the inertial information is regarded as other than the moving body, and the self-position is calculated by using the other image areas.

As described above, according to the third embodiment, even in the case where the moving body movement information obtaining section 602 does not exist, it is possible to calculate the world coordinate system self-position 604 based on the information obtained from the image pickup apparatus 105 and the inertial sensor 106.

According to the present disclosure, it is possible to reduce the difference between the user's vision and bodily sensation even during riding on the vehicle, and it is possible to prevent the decrease in the immersion sense in the display using the XR technology.

The present disclosure includes the following configurations and method.
(Configuration 1) An information processing apparatus comprising one or more processors and/or circuitry configured to:
   execute a position obtainment processing that obtains a position and an attitude of a user of a head mounted display;
   execute a movement information obtainment processing that obtains movement information of a moving body on which the user is riding;
   execute a rendering processing that renders a first CG object based on the position and the attitude of the user and renders a second CG object based on the movement information of the moving body; and
   execute a display processing that displays an image including the first CG object and the second CG object.
(Configuration 2) The information processing apparatus according to configuration 1, wherein
   in the rendering processing, a first rendering processing for rendering the first CG object is executed, and a second rendering processing for rendering the second CG object is executed.
(Configuration 3) The information processing apparatus according to configuration 1, wherein
   the one or more processors and/or circuitry is further configured to execute a composite processing that composites an image that is a result of rendering the first CG object by the rendering processing with an image that is a result of rendering the second CG object by the rendering processing, and in the display processing, an image composited by the composite processing is displayed.
(Configuration 4) The information processing apparatus according to configuration 1, wherein
   in the rendering processing, a display position or a display velocity of the second CG object is adjusted based on acceleration information of the moving body.
(Configuration 5) The information processing apparatus according to configuration 1, wherein
   the second CG object is an object for causing an entire virtual space to move in accordance with a movement of the moving body.
(Configuration 6) The information processing apparatus according to configuration 1, wherein
   in the position obtainment processing, an image pickup apparatus and an inertial sensor are used to obtain the position and the attitude of the user.
(Configuration 7) The information processing apparatus according to configuration 1, wherein
   the first CG object is a CG object set for each application, and
   the second CG object is an application-independent CG object.
(Configuration 8) The information processing apparatus according to configuration 3, wherein
   in the composite processing, the result of rendering the first CG object and the result of rendering the second CG object are composited based on depth information of the first CG object and the second CG object.
(Configuration 9) The information processing apparatus according to configuration 1, wherein
   in the rendering processing, the first CG object and the second CG object are rendered by being superimposed on a surrounding real video image obtained by an image pickup apparatus.
(Configuration 10) The information processing apparatus according to configuration 1, wherein
   in the movement information obtainment processing, the movement information is obtained from the moving body through wireless communication.
(Configuration 11) The information processing apparatus according to configuration 1, wherein
   in the rendering processing, display positions of the first CG object and the second CG object are adjusted in order to match the user's bodily sensation with the user's vision.
(Configuration 12) The information processing apparatus according to configuration 1, wherein
   the one or more processors and/or circuitry is further configured to, in a case where the movement information is not capable of being obtained by the movement information obtainment processing, execute a calculation processing that estimates movement information of the moving body from changes in the position and the attitude of the user that have been obtained by the position obtainment processing.
(Configuration 13) The information processing apparatus according to configuration 1, wherein
   the second CG object is a background image that changes dynamically in accordance with a moving direction and a velocity of the moving body.
(Configuration 14) The information processing apparatus according to configuration 1, wherein
   the one or more processors and/or circuitry is further configured to execute a control processing that controls display of at least one of the first CG object and the second CG object in accordance with a mode selected by the user.
(Configuration 15) The information processing apparatus according to configuration 1, wherein
   in the rendering processing, the movement information that has been obtained by the movement information obtainment processing and the position and the attitude of the user that have been obtained by the position obtainment processing are integrated to correct a virtual viewpoint.
(Method 1) A control method for an information processing apparatus, the control method comprising:
   a position obtaining step of obtaining a position and an attitude of a user of a head mounted display;
   a movement information obtaining step of obtaining movement information of a moving body on which the user is riding;
   a rendering step of rendering a first CG object based on the position and the attitude of the user and rendering a second CG object based on the movement information of the moving body; and
   a display step of displaying an image including the first CG object and the second CG object.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-118625, filed Jul. 24, 2024, which is hereby incorporated by reference herein in its entirety.

What is claimed is:

1. An information processing apparatus comprising one or more processors and/or circuitry configured to:
execute a position obtainment processing that obtains a position and an attitude of a user of a head mounted display;
execute a movement information obtainment processing that obtains movement information of a moving body on which the user is riding;
execute a rendering processing that renders a first CG object based on the position and the attitude of the user and renders a second CG object based on the movement information of the moving body; and
execute a display processing that displays an image including the first CG object and the second CG object.

2. The information processing apparatus according to claim 1, wherein
in the rendering processing, a first rendering processing for rendering the first CG object is executed, and a second rendering processing for rendering the second CG object is executed.

3. The information processing apparatus according to claim 1, wherein
the one or more processors and/or circuitry is further configured to execute a composite processing that composites an image that is a result of rendering the first CG object by the rendering processing with an image that is a result of rendering the second CG object by the rendering processing, and
in the display processing, an image composited by the composite processing is displayed.

4. The information processing apparatus according to claim 1, wherein
in the rendering processing, a display position or a display velocity of the second CG object is adjusted based on acceleration information of the moving body.

5. The information processing apparatus according to claim 1, wherein
the second CG object is an object for causing an entire virtual space to move in accordance with a movement of the moving body.

6. The information processing apparatus according to claim 1, wherein
in the position obtainment processing, an image pickup apparatus and an inertial sensor are used to obtain the position and the attitude of the user.

7. The information processing apparatus according to claim 1, wherein
the first CG object is a CG object set for each application, and
the second CG object is an application-independent CG object.

8. The information processing apparatus according to claim 3, wherein
in the composite processing, the result of rendering the first CG object and the result of rendering the second CG object are composited based on depth information of the first CG object and the second CG object.

9. The information processing apparatus according to claim 1, wherein
in the rendering processing, the first CG object and the second CG object are rendered by being superimposed on a surrounding real video image obtained by an image pickup apparatus.

10. The information processing apparatus according to claim 1, wherein
in the movement information obtainment processing, the movement information is obtained from the moving body through wireless communication.

11. The information processing apparatus according to claim 1, wherein
in the rendering processing, display positions of the first CG object and the second CG object are adjusted in order to match the user's bodily sensation with the user's vision.

12. The information processing apparatus according to claim 1, wherein
the one or more processors and/or circuitry is further configured to, in a case where the movement information is not capable of being obtained by the movement information obtainment processing, execute a calculation processing that estimates movement information of the moving body from changes in the position and the attitude of the user that have been obtained by the position obtainment processing.

13. The information processing apparatus according to claim 1, wherein
the second CG object is a background image that changes dynamically in accordance with a moving direction and a velocity of the moving body.

14. The information processing apparatus according to claim 1, wherein
the one or more processors and/or circuitry is further configured to execute a control processing that controls display of at least one of the first CG object and the second CG object in accordance with a mode selected by the user.

15. The information processing apparatus according to claim 1, wherein
in the rendering processing, the movement information that has been obtained by the movement information obtainment processing and the position and the attitude of the user that have been obtained by the position obtainment processing are integrated to correct a virtual viewpoint.

16. A control method for an information processing apparatus, the control method comprising:
a position obtaining step of obtaining a position and an attitude of a user of a head mounted display;
a movement information obtaining step of obtaining movement information of a moving body on which the user is riding;
a rendering step of rendering a first CG object based on the position and the attitude of the user and rendering a second CG object based on the movement information of the moving body; and
a display step of displaying an image including the first CG object and the second CG object.

17. A non-transitory computer-readable storage medium storing a program for causing a computer to execute a control method for an information processing apparatus, the control method comprising:
a position obtaining step of obtaining a position and an attitude of a user of a head mounted display;
a movement information obtaining step of obtaining movement information of a moving body on which the user is riding;
a rendering step of rendering a first CG object based on the position and the attitude of the user and rendering a second CG object based on the movement information of the moving body; and
a display step of displaying an image including the first CG object and the second CG object.
